(19) United States
(12) Patent Application Publication
(10) Pub. No.: US 2026/0008141 A1
(43) Pub. Date: Jan. 8, 2026

(54) MACHINE TOOL AND METHOD FOR OPERATING A MACHINE TOOL

(71) Applicant: Fill Gesellschaft m.b.H., Gurten (AT)

(72) Inventors: Michael SCHNEIDERBAUER, Andrichsfurt (AT); Johannes FISCHER, Gurten (AT); Reinhard SCHACHINGER, St. Martin (AT)

(21) Appl. No.: 18/881,715

(22) PCT Filed: Jul. 7, 2023
(86) PCT No.: PCT/AT2023/060227

§ 371 Date: Jan. 6, 2025

(30) Foreign Application Priority Data
Jul. 7, 2022 (AT) A50499/2022

(51) Int. Cl. B23Q 1/25; B23Q 11/00; B23Q 39/04

(52) U.S. Cl. CPC B23Q 1/25; B23Q 11/0028; B23Q 39/04

(57) ABSTRACT

A machine tool includes a base frame, a work spindle for receiving a tool, and a swivelling bridge for receiving a workpiece, wherein the swivelling bridge is configured such that it can swivel about a swivel axis, and wherein the swivelling bridge is received such that it can swivel on a first swivel bearing and a second swivel bearing. A workpiece holder for directly or indirectly receiving the workpiece is provided on the swivelling bridge, wherein the workpiece holder is arranged between the first swivel bearing and the second swiven bearing. The movements of the machine tool are controlled by a digital computer. A deflection compensation device for compensating for tilting of the workpiece due to deflection of the swivelling bridge is provided on the swivelling bridge.

### RELATED APPLICATIONS

This is a national stage under 35 U.S.C. § 371 of International Application No. PCT/AT2023/060227, filed Jul. 7, 2023, which claims priority of Austrian Patent Application No. A50499/2022, filed Jul. 7, 2022.

### TECHNICAL FIELD

The field of the present disclosure relates to a machine tool and to a method for operating a machine tool.

### BACKGROUND

WO2018209373A1 discloses a machine tool that comprises the following components:
a machine frame;
a spindle adjustment device arranged on the machine frame;
at least a first work spindle which is pivoted about a first spindle axis;
at least a second work spindle which is pivoted about a second spindle axis;
a workpiece clamping device which is arranged on the machine frame and is configured to receive at least a first workpiece and a second workpiece.

The spindle adjustment device comprises a working head on which the work spindle is arranged. The workpiece clamping device comprises at least one workpiece table, wherein the first workpiece table is mounted such that it can swivel about a first swivel axis.

The machine tool known from WO2018209373A1 has the disadvantage that tools produced by it can have imprecisions.

The imprecisions can arise from the fact that due to the weight force of the swivelling bridge or due to the weight force of the workpiece, the swivelling bridge can deflect in an elastic deformation. The deflection of the swivelling bridge causes tilting of the workpieces received on the swivelling bridge. If, for instance, round tables for receiving workpieces are received on the swivelling bridge, tilting of the round table is caused by the deflection of the swivelling bridge.

Thus, the present inventors identified a need for improved devices and methods by means of which a workpiece can be produced with increased precision.

### SUMMARY

A machine tool according to an embodiment of the present disclosure comprises:
a base frame;
a work spindle for receiving a tool;
a swivelling bridge for receiving a workpiece, wherein the swivelling bridge is configured such that it can swivel about a swivel axis, wherein the swivelling bridge is received such that it can swivel on a first swivel bearing and a second swivel bearing, wherein a workpiece holder for directly or indirectly receiving the workpiece is provided on the swivelling bridge, wherein the workpiece holder is arranged between the first swivel bearing and the second swivel bearing;
a digital computer for controlling the movements of the machine tool.

A deflection compensation device for compensating for tilting of the workpiece due to deflection of the swivelling bridge is provided on the swivelling bridge.

The machine tool according to a disclosed embodiment provides the advantage that the workpieces can be produced with increased precision due to the deflection compensation device. This can be achieved in particular in that the gravity-related deflection of the swivelling bridge can be countered by means of the deflection compensation device. In particular, tilting of the workpiece can be compensated for by means of the deflection compensation device.

Furthermore, it can be expedient if a first workpiece holder for receiving a first workpiece and a second workpiece holder for receiving a second workpiece are provided on the swivelling bridge, wherein the first workpiece holder is arranged on a first side of the longitudinal center at a first distance from the longitudinal center of the swivelling bridge and wherein the second workpiece holder is arranged on a second side of the longitudinal center at a second distance from the longitudinal center of the swivelling bridge. In particular in the case of two workpiece holders, which are each arranged at a distance from the longitudinal center of the swivelling bridge, tilting of the workpiece holder and thus tilting of the workpiece occurs in the event of deflection of the swivelling bridge. The use of a deflection compensation device has proven advantageous in particular in such a machine configuration.

Furthermore, it can be provided that the first distance and the second distance are equal. This provides the advantage that the first workpiece holder and the second workpiece holder have an equal tilting and thus tilting can be compensated for with an equal force action.

Furthermore, it can be provided that the deflection compensation device is coupled with the first workpiece holder and with the second workpiece holder, wherein an opposing force can be applied to the first workpiece holder and the second workpiece holder by the deflection compensation device. This provides the advantage that a deformation of the first workpiece holder and of the second workpiece holder can be achieved by the force action on the first workpiece holder and the second workpiece holder. The first workpiece holder and the second workpiece holder can thus be compensated for in their angular position by the application of an opposing force. In particular, the deflection compensation device can rest on the first workpiece holder and the second workpiece holder, such that no force is applied to any further components of the swivelling bridge, which could otherwise lead to an undesired further deformation of the swivelling bridge.

Furthermore, it can be provided that a first lever is coupled with the first workpiece holder and in that a second lever is coupled with the second workpiece holder, and in that a force can be applied to the first lever and to the second lever by the deflection compensation device, wherein a bending moment can be applied to the first workpiece holder and to the second workpiece holder by the application of said force. In particular such an embodiment of a first lever and a second lever provides the advantage that a bending moment can be introduced into the workpiece holders, whereby tilting of the workpiece holders can be compensated for.

An embodiment according to which it can be provided that the deflection compensation device comprises a linear actuator, in particular a hydraulic cylinder, wherein the linear actuator is coupled with the first lever at a first coupling point and with the second lever at a second coupling point, is also advantageous. In particular by means of a linear actuator, a force can be applied simply to the lever, whereby a bending moment can be introduced. In particular, it can be provided that the linear actuator is configured as a hydraulic cylinder. Such a hydraulic cylinder can apply a high force to the levers, whereby a high bending moment can be introduced into the workpiece holder in order to compensate for an angular misalignment of the workpiece.

Alternatively to the embodiment of a linear actuator in connection with a lever, it can also be provided that a swivel actuator is provided to directly apply a bending moment to the workpiece holders. Such a swivel actuator can, for example, be a hydraulic swivel cylinder.

According to a further embodiment, it is possible that the the deflection compensation device comprises a first linear actuator, in particular a first hydraulic cylinder, wherein the first linear actuator is coupled with the first lever at a first coupling point and with the swivelling bridge at a second coupling point and the deflection compensation device comprises a second linear actuator, in particular a second hydraulic cylinder, wherein the second linear actuator is coupled with the second lever at a third coupling point and with the swivelling bridge at a fourth coupling point. In such an embodiment, the bending moment can be introduced in the first workpiece holder and the second workpiece holder separately and independently from one another. Any angle errors of the first workpiece holder and the second workpiece holder can thus be compensated for independently of one another.

Alternatively to the use of a first linear actuator and a second linear actuator, it can be provided that a single linear actuator with a central housing for connection to the swivelling bridge and with a first piston rod for connection to the first lever and a second piston rod for connection to the second lever is provided.

Alternatively to the linear actuator in the form of a hydraulic cylinder, it can be provided that the linear actuator is provided in the form of an electrically driven linear actuator, for instance with a stepper motor.

When using a linear actuator in the form of a hydraulic cylinder, it can be provided that it is coupled with a proportional valve that serves to displace the hydraulic cylinder.

Furthermore, it can be expedient if the first lever is rigidly coupled with the first workpiece holder and the second lever is rigidly coupled with the second workpiece holder, wherein the first workpiece holder and the second workpiece holder are rigidly held in the swivelling bridge and an elastic deformation of the workpiece holders and/or of the swivelling bridge is initiated by the force applied to the first lever and the second lever. In such an embodiment, the elasticity or the component stiffness of the swivelling bridge is used to compensate for tilting by corresponding bending. This provides the advantage that the workpiece holders do not have to be received in the swivelling bridge such that they can swivel.

Furthermore, it can be provided that the workpiece holder comprises a round table, which is configured to rotate the workpiece about an axis of rotation, wherein the axis of rotation of the round table is arranged at a right angle to the swivel axis of the swivelling bridge when the swivelling bridge is not deformed. In particular, it can be provided that the axis of rotation of the round table intersects the swivel axis. In particular, a machine tool configured in such a way has high flexibility with regard to workpiece processing. Possible tilting of the round table can be compensated for by the deflection compensation device.

In addition, it can be provided that the first workpiece holder comprises a first round table, which is configured to rotate the first workpiece about a first axis of rotation, wherein the first axis of rotation of the first round table is arranged at a right angle to the swivel axis when the swivelling bridge is not deformed, and in that the second workpiece holder comprises a second round table, which is configured to rotate the second workpiece about a second axis of rotation, wherein the second axis of rotation of the second round table is arranged at a right angle to the swivel axis when the swivelling bridge is not deformed. In particular, a machine tool configured in such a way has high flexibility with regard to workpiece processing. Possible tilting of the round table can be compensated for by the deflection compensation device.

According to a particular embodiment, it is possible that a sensor for detecting tilting of the workpiece or of the workpiece holder is provided, wherein the sensor is coupled with the digital computer and the deflection compensation device can be controlled on the basis of the value detected by the sensor. This provides the advantage that in a control loop the actual tilting of the workpiece can be compensated for, whereby possible environmental influences such as temperature, weight of the workpiece, a change of the Young's modulus of the swivelling bridge due to aging and the like need not be considered in a calculation, but can rather be considered in the direct measurement.

According to an advantageous further embodiment, it can be provided that a mechanical sliding guide is provided, wherein an adjustment of the deflection compensation device is performed on the basis of the swivel position of the swivelling bridge. In such an embodiment, it is not necessary that a separate actuator or a separate energy supply is available for deflection compensation.

Rather, the deflection compensation can be achieved by forced guidance.

A method for operating a machine tool comprising the method steps:
receiving a tool in a work spindle;
receiving a workpiece on a swivelling bridge, wherein the swivelling bridge is swivelled about a swivel axis during operation of the machine tool, wherein the swivelling bridge is configured such that it can swivel about a swivel axis, wherein the swivelling bridge is received such that it can swivel on a first swivel bearing and a second swivel bearing, wherein a workpiece holder for directly or indirectly receiving the workpiece is provided on the swivelling bridge, wherein the workpiece holder is arranged between the first swivel bearing and the second swivel bearing;
controlling the movements of the machine tool by means of a digital computer.

Tilting of the workpiece is compensated for by means of a deflection compensation device arranged on the swivelling bridge, wherein tilting of the workpiece is caused by a deflection of the swivelling bridge due to the weight force of the swivelling bridge and the parts on it.

The method according to an embodiment provides the advantage that the workpieces can be produced with increased precision due to the deflection compensation device. This can be achieved in particular in that the gravity-related deflection of the swivelling bridge can be countered by means of the deflection compensation device. In particular, a tilting of the workpiece can be compensated for by means of the deflection compensation device.

Moreover, it can be provided that tilting of the workpiece is detected by a sensor, wherein the sensor is coupled with the digital computer and the deflection compensation device is controlled on the basis of the value detected by the sensor. This provides the advantage that in a control loop the actual tilting of the workpiece can be compensated for, whereby possible environmental influences such as temperature, weight of the workpiece, a change of the elasticity module of the swivelling bridge due to aging and the like need not be considered in a calculation, but can rather be considered in the direct measurement.

Furthermore, it can be provided that the deflection compensation device is controlled on the basis of the swivel position of the swivelling bridge. This provides the advantage that different deflections caused by different swivel positions of the swivelling bridge can be compensated for.

An embodiment according to which it can be provided that the deflection compensation device is controlled on the basis of the swivel position of the swivelling bridge, wherein tilting of the workpiece is detected by a sensor, wherein the control commands of the digital computer are automatically adjusted on the basis of the value detected in the sensor, in particular in that teaching-in of the compensation adjustments is performed in the digital computer, is advantageous. This provides the advantage that not only a measured value of the angular misalignment can be compensated for, but rather that an angular misalignment to be anticipated can already be compensated for upon or even before its occurrence, such that no actual angular misalignment occurs during processing of the workpiece, and is rather already compensated for in advance by the respective knowledge of the values to be anticipated. In particular, it is conceivable that by using artificial intelligence or neural networks, the processing unit of the machine tool can thereby be trained accordingly in order to achieve exact compensation for tilting.

According to a further embodiment, it is possible that the weight of the workpiece is acquired, wherein the deflection compensation device is controlled in consideration of the weight of the workpiece. This provides the advantage that a different deflection can be considered for different workpieces.

In particular, it can be advantageous if the deflection of the swivelling bridge is simulated with various workpiece weights in a computer-implemented simulation model, in particular in a finite element model, and is stored in a deflection database, wherein the deflection compensation device is controlled on the basis of the data from the deflection database. This provides the advantage that the deflection compensation can be performed on the basis of an expected deflection of the swivelling bridge. The actual tilting of the workpiece or of the workpiece holder can thus be compensated for during the different swivel positions of the swivelling bridge in the course of the processing of the workpiece. It is thus possible to cause no or as little tilting of the workpiece as possible during the entire processing of the workpiece, whereby the precision of the workpiece can be improved.

### BRIEF DESCRIPTION OF THE DRAWINGS

For a better understanding of the invention, embodiments are explained in more detail with reference to the following figures.

These show in significantly simplified, schematic representation:

FIG. 1 a schematic representation of a first example embodiment of a machine tool;

FIG. 2 a schematic representation of a deflection of a swivelling bridge of the machine tool;

FIG. 3 a schematic representation of a first example embodiment of the swivelling bridge with a deflection compensation device;

FIG. 4 a schematic representation of a second example embodiment of the swivelling bridge with the deflection compensation device;

FIG. 5 a schematic representation of a third example embodiment of the swivelling bridge with the deflection compensation device;

FIG. 6 a schematic representation of a fourth example embodiment of the swivelling bridge with the deflection compensation device.

### DETAILED DESCRIPTION OF EXEMPLARY EMBODIMENTS

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

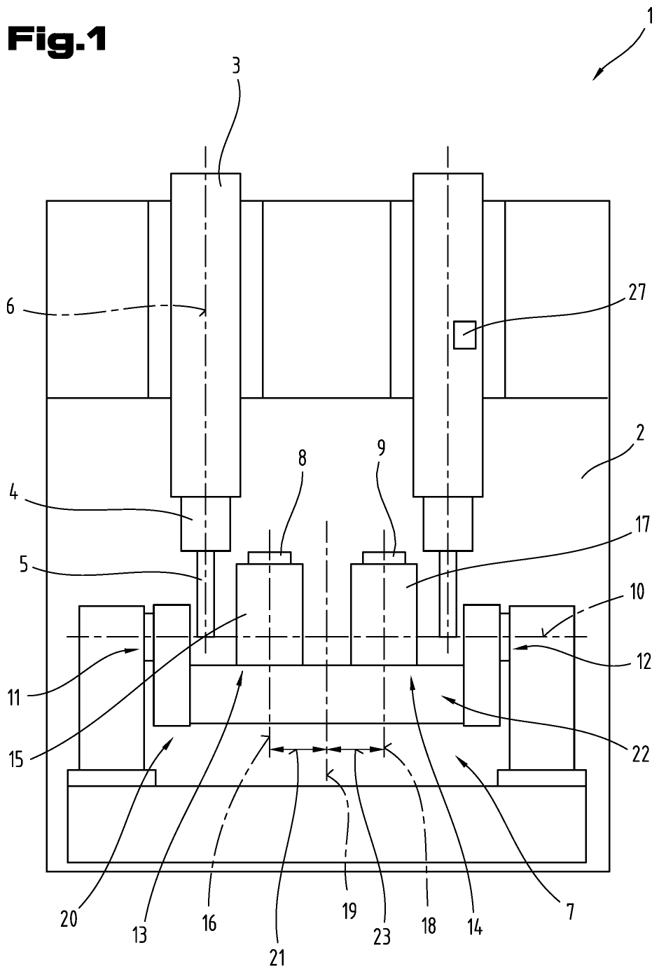

FIG. 1 shows a first example embodiment of a machine tool 1. In particular, it can be provided that the machine tool 1 serves to machine workpieces.

The machine tool 1 can have a base frame 2. The base frame 2 can serve to receive various movable components of the machine tool 1. Moreover, it can be provided that the machine tool 1 has a machining head 3. A work spindle 4 can be received in the machining head 3. The work spindle 4 can serve to receive a tool 5. In particular, it can be provided that the tool 5 is rotated about a spindle axis 6 by the work spindle 4. Moreover, it can be provided that the machine tool 1 has two or more work spindles 4. The work spindles 4 can thereby each be arranged on their own machining head 3 or on a shared machining head 3.

As can further be seen from FIG. 1, it can be provided that the machine tool 1 comprises a swivelling bridge 7, which can serve to receive a first workpiece 8 or a second workpiece 9. The swivelling bridge 7 can be configured such that it can swivel about a swivel axis 10 relative to the base frame 2. In particular, it can be provided that the swivelling bridge 7 is coupled with the base frame 2 by means of a first swivel bearing 11 and a second swivel bearing 12. The swivelling bridge 7 can thereby extend between the first swivel bearing 11 and the second swivel bearing 12.

The receiving of the swivelling bridge 7 on the first swivel bearing 11 and on the second swivel bearing 12 can lead to a deflection of the central part of the swivelling bridge 7. The deflection can thereby be caused by the tare weight of the swivelling bridge 7 or by the weight of the workpiece 8, 9 or by the weight of workpiece holders or clamping devices received on the swivelling bridge 7. The deflection can be of varying extent depending on the component stiffness or Young's modulus of the swivelling bridge 7. A further factor affecting the extent of deflection is the angular position of the swivelling bridge 7 with regard to its rotation about the swivel axis 10. In particular, it is possible that a maximum deflection value is reached when the swivelling bridge 7 is in a position as shown in FIG. 1.

Where the swivelling bridge is swivelled by 180° and the workpieces are thus located below it, a maximum deflection value can be reached in the opposite direction. Where in comparison to FIG. 1 the swivelling bridge 7 is swivelled by 90°, the deflection of the swivelling bridge 7 relevant to tilting of the workpieces to one another can be zero or almost zero. However, where the swivelling bridge 7 is swivelled by 90°, there can be a lateral deflection of the swivelling bridge 7.

As can further be seen in FIG. 1, it can be provided that a first workpiece holder 13 is provided for receiving the first workpiece 8. Moreover, a second workpiece holder 14 can be provided for receiving the second workpiece 9. The first workpiece holder 13 and the second workpiece holder 14 can serve to directly or indirectly receive the first workpiece 8 or the second workpiece 9 on the swivelling bridge 7.

In the example embodiment according to FIG. 1, the workpieces 8, 9 are indirectly received on the swivelling bridge 7. In particular, a first round table 15 is thereby provided for receiving the first workpiece 8. The first round table 15 can be provided for rotating the first workpiece 8 about a first axis of rotation 16. In the same way, it can be provided that a second round table 17 is provided for receiving the second workpiece 9. By means of the second round table 17, the second workpiece 9 can be received such that it can be rotated about a second axis of rotation 18 relative to the swivelling bridge 7.

As can further be seen from FIG. 1, it can be provided that the first workpiece holder 13 and the second workpiece holder 14 are arranged eccentrically on the swivelling bridge 7 in relation to a longitudinal center 19 on the swivelling bridge 7. It can thereby be provided that the first workpiece holder 13 and the second workpiece holder 14 are arranged in a symmetrical arrangement that is eccentric in relation to the longitudinal center 19 on the swivelling bridge 7.

In particular, it can be provided that the first workpiece holder 13 is arranged on a first side 20 of the longitudinal center 19. Moreover, it can be provided that the first workpiece holder 13 is arranged at a first distance 21 to the longitudinal center 19. It can further be provided that the second workpiece holder 14 is arranged on a second side 22 of the longitudinal center 19. The second workpiece holder 14 can thereby be arranged at a second distance 23 from the longitudinal center 19. Where the first workpiece holder 13 and the second workpiece holder 14 are arranged symmetrically, the first distance 21 and the second distance 23 can be equal.

As is schematically represented in FIG. 1, a digital computer 27 can be provided that can serve to control the machine tool 1.

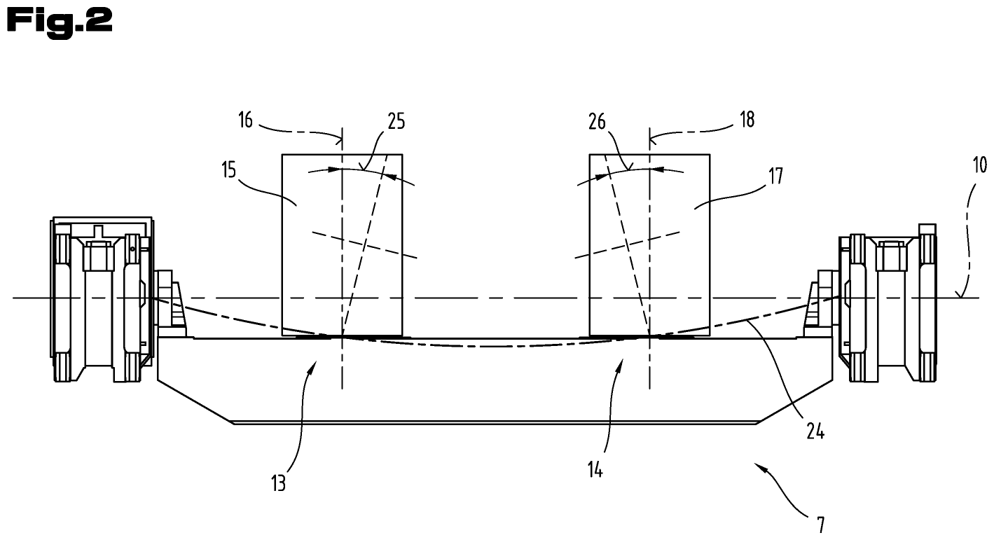

FIG. 2 shows a further and possibly independent embodiment of the swivelling bridge 7, where the same reference numerals or component designations are used for the same parts as in the preceding FIG. 1. To avoid unnecessary repetition, reference is made to the detailed description in the preceding FIG. 1.

FIG. 2 shows a schematic representation of an example embodiment of the swivelling bridge 7 or more specifically the deflection occurring on the swivelling bridge 7.

As can be seen from FIG. 2, it can be provided that the swivelling bridge 7 has a cranking. In the main position of the swivelling bridge 7 as shown in FIG. 2, the first workpiece holder 13 or the second workpiece holder 14 can thereby be configured with a downward offset in relation to the swivel axis 10. A deflection of the swivelling bridge 7 can thereby occur in the direction of this cranking. The swivelling bridge 7 can thereby be bent as per a bend line 24 shown in exaggerated representation.

Since, with a corresponding deflection as can be seen from FIG. 2, the bend line 24 has an angular position in the region of the first workpiece holder 13 and in the region of the second workpiece holder 14, the first workpiece holder 13 or the second workpiece holder 14 thus also has a corresponding angular misalignment.

In particular, it can be provided that in a swivel position of the swivelling bridge 7 as shown in FIG. 2, the first round table 15 is tilted inwards by a first angle 25. Furthermore, the second round table 17 can be tilted inwards by a second angle 26. The first round table 15 and the second round table 17 can thus be tilted towards one another on their side facing away from the swivelling bridge 7.

If the swivelling bridge 7 is swivelled by an angle of 180° in relation to the position as shown in FIG. 2, an opposed bending will then set in and the two round tables 15, 17 are tilted away from each other on their sides facing away from the swivelling bridge 7.

Between the first swivel position of the swivelling bridge 7 as shown in FIG. 2 and a second swivel position rotated by 180°, the first angle 25 or the second angle 26 continuously decrease and reach a zero degree deviation at approximately 90° swivel position of the swivelling bridge 7.

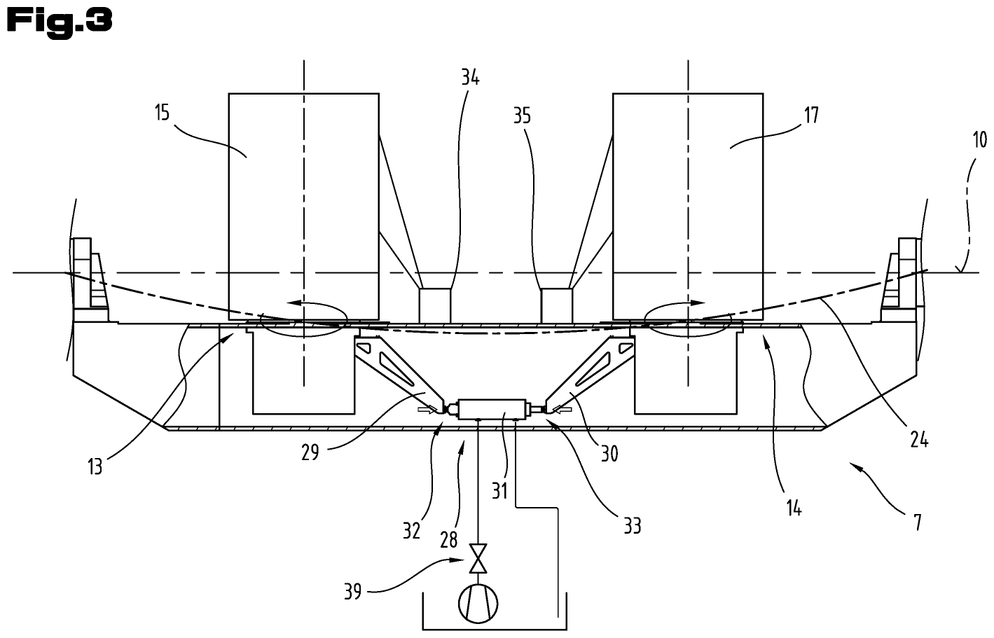

FIG. 3 shows a further example embodiment of the swivelling bridge 7, where the same reference numerals or component designations are used for the same parts as in the preceding FIGS. 1 and 2. To avoid unnecessary repetition, reference is made to the detailed description in the preceding FIGS. 1 and 2.

As can be seen from FIG. 3, it can be provided that a deflection compensation device 28 is provided on the swivelling bridge 7, which can be used for the targeted adjustment of the bend line 24 and thus to compensate for the angular misalignment of the first round table 15 or the second round table 17. The first angle 25 and the second angle 26 can be influenced by the deflection compensation device 28 in such a way that they are zero, irrespective of the swivel position of the swivelling bridge 7.

As can further be seen from FIG. 3, it can be provided that a first lever 29 is coupled with the first workpiece holder 13. It can further be provided that a second lever 30 is coupled with the second workpiece holder 14. As can further be seen from FIG. 3, it can be provided that the deflection compensation device 28 comprises a first linear actuator 31, which is provided in the form of a hydraulic cylinder. The first linear actuator 31 can be coupled with the first lever 29 at a first coupling point 32. In particular, it can be provided that the first linear actuator 31 has a direction of action that is parallel to the swivel axis 10.

Moreover, the first linear actuator 31 can be coupled with the second lever 30 at a second coupling point 33. Furthermore, it can be provided that the first linear actuator 31 is not attached to the swivelling bridge 7 between the first coupling point 32 and the second coupling point 33. The first lever 29 can thus act as an abutment for the second lever 30 and an equal force can be applied to the first lever 29 or to the second lever 30. The force applied to the first lever 29 or the second lever 30 can introduce a bending moment in the first workpiece holder 13 or in the second workpiece holder 14, where said bending moment can serve to influence the bend line 24 and thus compensate for the angular misalignment of the first angle 25 and the second angle 26.

As can further be seen from FIG. 3, it can be provided that a first sensor 34 is provided, which can serve to detect the first angle 25. Moreover, a second sensor 35 can be provided, which can serve to detect the second angle 26.

As can further be seen from FIG. 3, it can be provided that the first linear actuator 31 is coupled with a first valve 39, which can serve to control the first linear actuator 31. The first valve 39 can be provided in the form of a proportional valve.

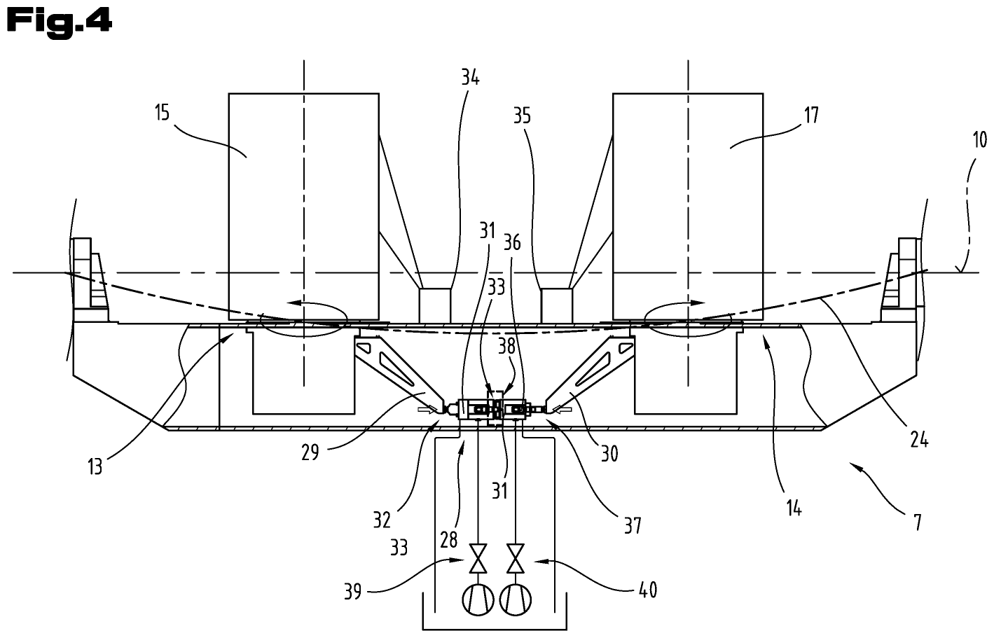

FIG. 4 shows a further example embodiment of the swivelling bridge 7, where the same reference numerals or component designations are used for the same parts as in the preceding FIG. 1 to 3. To avoid unnecessary repetition, reference is made to the detailed description in the preceding FIG. 1 to 3.

As can be seen from FIG. 4, it can be provided that the first linear actuator 31 is coupled with the first lever 29 at a first coupling point 32 and with the swivelling bridge 7 at a second coupling point 33.

Furthermore, a second linear actuator 36 can be provided, which is coupled with the second lever 30 at a third coupling point 37 and with the swivelling bridge 7 at a fourth coupling point 38. The first linear actuator 31 and the second linear actuator 36 can thereby be driven independently of one another, such that a different force action can be achieved on the first lever 29 and on the second lever 30. These measures mean that the first angle 25 and the second angle 26 can be influenced independently of one another.

As can further be seen from FIG. 4, it can be provided that the first linear actuator 31 is coupled with a first valve 39, which can serve to control the first linear actuator 31. The first valve 39 can be provided in the form of a proportional valve.

As can further be seen from FIG. 4, it can be provided that the second linear actuator 36 is coupled with a second valve 40. The second valve 40 can serve to control the second linear actuator 36. The second valve 40 can be provided in the form of a proportional valve.

In the example embodiment according to FIG. 4, the first linear actuator 31 and the second linear actuator 36 can be provided as structurally independent units, which can be coupled with the swivelling bridge 7 at the first coupling point 32 or at the fourth coupling point 38. The first linear actuator 31 and the second linear actuator 36 can thus be coupled with the swivelling bridge 7 at the first coupling point 32 or at the fourth coupling point 38 such that they cannot be displaced in the direction of action.

In an alternative embodiment, it is also conceivable that the first linear actuator 31 and the second linear actuator 36 have a shared housing, which can be coupled with the swivelling bridge 7 such that it cannot be displaced in the direction of action.

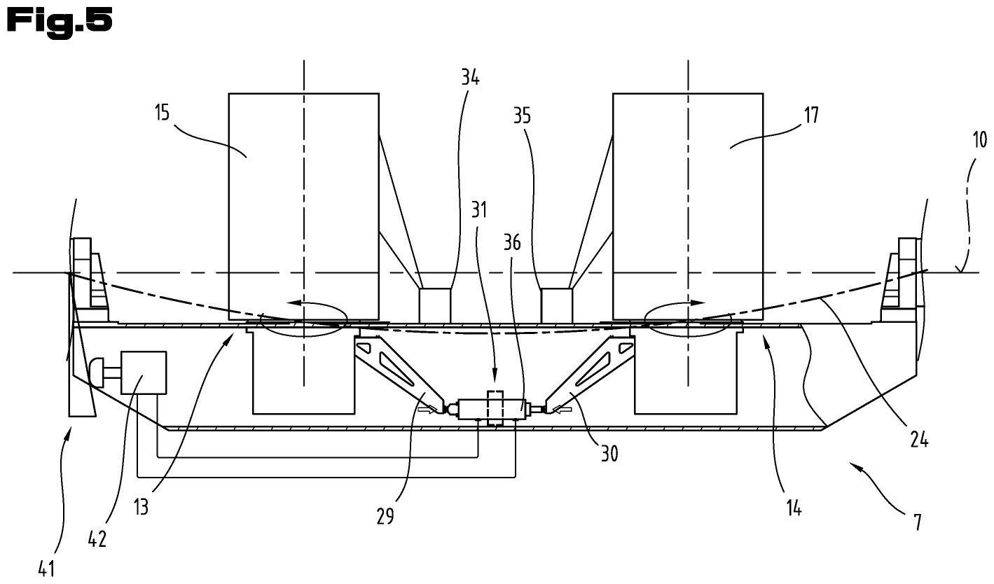

FIG. 5 shows a further example embodiment of the swivelling bridge 7, where the same reference numerals or component designations for the same parts as in the preceding FIG. 1 to 4. To avoid unnecessary repetition, reference is made to the detailed description in the preceding FIG. 1 to 4.

As can be seen from FIG. 5, it can be provided that the first linear actuator 31 is coupled with a sliding guide 41, wherein the force application of the linear actuator 31 varies depending on the swivel angle position of the swivelling bridge 7. In particular, it can be provided that the first linear actuator 31 is coupled with an operating actuator 42 by a line connection. The operating actuator 42 can thereby be swivelled together with the swivelling bridge 7 and rest on the sliding guide 41. Different degrees of force application can thus be achieved on the first linear actuator 31 depending on the swivel angle position of the swivelling bridge 7.

In an alternative embodiment variation to that shown in FIG. 5, and not shown here in detail, it can also be provided that the first lever 29 is mechanically coupled with the sliding guide 41 by means of a rod.

A possible method sequence for operating a machine tool is described in the following. A tool 5 can be brought into processing engagement to process the workpiece 8, 9, in particular to machine the workpiece 8, 9. The swivelling bridge 7 can thereby be swivelled about the swivel axis 10 during processing.

Different deflection of the swivelling bridge 7 occurs at different swivel positions of the swivelling bridge 7, whereby a different bend line 24 arises at different swivel positions.

To compensate for this deflection or the resulting misalignment of the first round table 15 and the second round table 17, the deflection compensation device 28 can introduce a bending moment into the first workpiece holder 13 and the second workpiece holder 14. The bending moment can be selected such that the first angle 25 and the second angle 26 amounts to 0° deviation from the ideal perpendicular position. In other words, the deflection compensation device 28 can allow for the first axis of rotation 16 of the first round table 15 and the second axis of rotation 18 of the second round table 17 to be parallel to one another or each be at a right angle to the swivel axis 10.

The degree of force application and thus of torque application can, for example, be determined in a control process in such a way that the current deviation of the first angle 25 and of the second angle 26 is detected by a first sensor 34 and optionally by a second sensor 35. In an alternative embodiment variation, it is also possible that the angle deviation of the first angle 25 and of the second angle 26 is simulated under different conditions using a finite element model and the simulation results are accordingly transferred into a compensation table, wherein the deflection compensation device 28 is controlled on the basis of the compensation table.

Furthermore, it is conceivable that a neural network is provided to control the deflection compensation device 28, the former being configured to correct the angle deviation of the first angle 25 and of the second angle 26 in such a temporally exact way that the first round table 15 and the second round table 17 experience practically no angle deviation throughout the process. The neural network can thereby be trained by simulation, again on the basis of a finite element model. Moreover, it is also conceivable that the neural network is trained during the running operation of the machine tool 1 or a reference machine tool. The first sensor 34 and/or the second sensor 35 can be installed on the machine tool 1 or the reference machine tool to train the neural network.

A reference machine tool can be a structurally identical machine tool 1 which has a plurality of sensors and serves to monitor the deformations of the swivelling bridge 7. Such a reference machine tool can, for example, be worthwhile in the case of series production, so that not every machine tool 1 has to have a comprehensive sensor assembly.

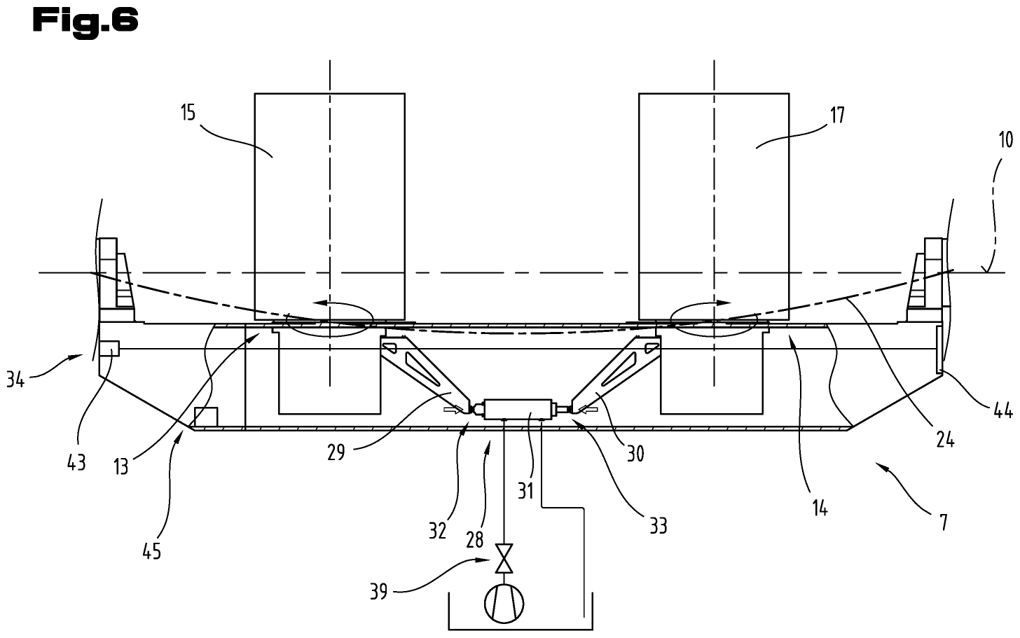

FIG. 6 shows a further example embodiment of the swivelling bridge 7, where the same reference numerals or component designations are used for the same parts as in the preceding FIG. 1 to 5. To avoid unnecessary repetition, reference is made to the detailed description in the preceding FIG. 1 to 5.

As can be seen from FIG. 6, it can be provided that the first sensor 34 has a transmitter 43 and a receiver 44. The transmitter 43 can thereby be arranged on a first longitudinal end of the swivelling bridge 7. The receiver 44 can be arranged on a second longitudinal end of the swivelling bridge. The transmitter 43 can emit an electromagnetic radiation, such as light, to the receiver 44. The deflection of the swivelling bridge 7 and thus the angular tilting of the workpieces 8, 9 can be deduced from the height displacement of the radiation at the receiver.

In a further, fully independent embodiment, it can be provided that the sensor 34 is configured as a linear measurement system 45. Such a linear measurement system 45 can be arranged on an outermost structural element of the swivelling bridge 7. Furthermore, it can be provided that the linear measurement system 45 is configured to measure an extension or compression of the outermost structural element of the swivelling bridge 7. The deflection of the swivelling bridge 7 and thus the angular tilting of the workpieces 8, 9 can thereby be deduced. In particular, it is conceivable that the linear measurement system 45 is provided in the form of a light-connected system. Moreover, it is also conceivable that the linear measurement system 45 is provided in the form of a strain gauge which detects the strain of a component of the swivelling bridge 7.

The example embodiments show possible embodiment variations, although it is to be noted here that the invention is not limited to the specifically represented embodiment variations of the same, but rather various combinations of the individual embodiment variations with one another are possible, and that given the technical teachings provided by the present disclosure this variation possibility is within the ability of the skilled person in this technical field.

The scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

1. A machine tool comprising:
a base frame;
a work spindle for receiving a tool;
a swivelling bridge for receiving a workpiece wherein the swivelling bridge is configured such that it can swivel about a swivel axis, wherein the swivelling bridge is received such that it can swivel on a first swivel bearing and a second swivel bearing, wherein a workpiece holder for directly or indirectly receiving the workpiece is provided on the swivelling bridge, wherein the workpiece holder is arranged between the first swivel bearing and the second swivel bearing;
a digital computer for controlling the movements of the machine tool;
wherein a deflection compensation device for compensating for tilting of the workpiece (8, 9) due to deflection of the swivelling bridge is provided on the swivelling bridge.

2. The machine tool according to claim 1, wherein a first workpiece holder for receiving a first workpiece and a second workpiece holder for receiving a second workpiece are provided on the swivelling bridge, wherein the first workpiece holder is arranged on a first side of the longitudinal center at a first distance from the longitudinal center of the swivelling bridge and wherein the second workpiece holder is arranged on a second side of the longitudinal center at a second distance from the longitudinal center of the swivelling bridge.

3. The machine tool according to claim 2, wherein the deflection compensation device is coupled with the first workpiece holder and with the second workpiece holder, wherein an opposing force can be applied to the first workpiece holder and the second workpiece holder by the deflection compensation device.

4. The machine tool according to claim 2, wherein a first lever is coupled with the first workpiece holder and in that a second lever is coupled with the second workpiece holder, and in that a force can be applied to the first lever and to the second lever by the deflection compensation device, wherein a bending moment can be applied to the first workpiece holder and to the second workpiece holder by the application of said force.

5. The machine tool according to claim 4, wherein the deflection compensation device comprises a linear actuator, in particular a hydraulic cylinder, wherein the linear actuator is coupled with the first lever at a first coupling point and with the second lever at a second coupling point.

6. The machine tool according to claim 4, wherein:
the deflection compensation device comprises a first linear actuator, in particular a first hydraulic cylinder, wherein the first linear actuator is coupled with the first lever at a first coupling point and with the swivelling bridge at a second coupling point point, and
the deflection compensation device comprises a second linear actuator, in particular a second hydraulic cylinder, wherein the second linear actuator is coupled with the second lever at a third coupling point and with the swivelling bridge at a fourth coupling point.

7. The machine tool according to claim 4, wherein the first lever is rigidly coupled with the first workpiece holder and the second lever is rigidly coupled with the second workpiece holder, wherein the first workpiece holder and the second workpiece holder are rigidly held in the swivelling bridge and an elastic deformation of the workpiece holders and/or of the swivelling bridge is initiated by the force applied to the first lever and the second lever.

8. The machine tool according to claim 1, wherein the workpiece holder comprises a round table, which is configured to rotate the workpiece about an axis of rotation, wherein the axis of rotation of the round table is arranged at a right angle to the swivel axis when the swivelling bridge is not deformed.

9. The machine tool according to claim 2, wherein the first workpiece holder comprises a first round table, which is configured to rotate the first workpiece about a first axis of rotation, wherein the first axis of rotation of the first round table is arranged at a right angle to the swivel axis when the swivelling bridge is not deformed, and in that the second workpiece holder comprises a second round table, which is configured to rotate the second workpiece about a second axis of rotation, wherein the second axis of rotation of the second round table is arranged at a right angle to the swivel axis when the swivelling bridge is not deformed.

10. The machine tool according to claim 1, wherein a sensor for detecting tilting of the workpiece or of the workpiece holder is provided, wherein the sensor is coupled with the digital computer and the deflection compensation device can be controlled on the basis of the value detected by the sensor.

11. The machine tool according to claim 1, wherein a mechanical sliding guide is provided, wherein an adjustment of the deflection compensation device is performed on the basis of the swivel position of the swivelling bridge.

12. A method for operating a machine tool comprising the method steps:
receiving a tool in a work spindle;
receiving a workpiece on a swivelling bridge, wherein the swivelling bridge is swivelled about a swivel axis during operation of the machine tool, wherein the swivelling bridge is received such that it can swivel on a first swivel bearing and a second swivel bearing, wherein a workpiece holder for directly or indirectly receiving the workpiece is provided on the swivelling bridge, wherein the workpiece holder is arranged between the first swivel bearing and the second swivel bearing;
controlling the movements of the machine tool by means of a digital computer;
wherein tilting of the workpiece is compensated for by a deflection compensation device arranged on the swivelling bridge, wherein tilting of the workpiece is caused by a deflection of the swivelling bridge due to the weight force of the swivelling bridge and the parts on it.

13. The method according to claim 12, wherein tilting of the workpiece is detected by a sensor, wherein the sensor is coupled with the digital computer and the deflection compensation device is controlled on the basis of the value detected by the sensor.

14. The method according to claim 12, wherein the deflection compensation device is controlled on the basis of the swivel position of the swivelling bridge.

15. The method according to claim 12, wherein the deflection compensation device is controlled on the basis of the swivel position of the swivelling bridge, wherein the titling of the workpiece is detected by a sensor, wherein the control commands of the digital computer are automatically adjusted on the basis of the value detected in the sensor), in particular in that a teaching-in of the compensation adjustments is performed in the digital computer.

16. The method according to claim 12, wherein the weight of the workpiece is detected, wherein the deflection compensation device is controlled in consideration of the weight of the workpiece.

17. The method according to claim 12, wherein the deflection of the swivelling bridge is simulated with various workpiece weights in a computer-implemented simulation model, in particular in a finite element model, and is stored in a deflection database, wherein the deflection compensation device is controlled on the basis of the data from the deflection database.
